(19) United States
(12) Patent Application Publication
(10) Pub. No.: US 2014/0048678 A1
(43) Pub. Date: Feb. 20, 2014

(54) SUPPORTING APPARATUS

(71) Applicants: HON HAI PRECISION INDUSTRY CO., LTD., New Taipei (TW); HONG FU JIN PRECISION INDUSTRY (Wuhan) CO., LTD., wUHAN (CN)

(72) Inventors: YUN-LUNG CHEN, New Taipei (TW); CHIN-WEN YEH, New Taipei (TW); YANG XIAO, Wuhan (CN); CHAO FENG, Wuhan (CN)

(21) Appl. No.: 13/919,115

(22) Filed: Jun. 17, 2013

(30) Foreign Application Priority Data
Aug. 17, 2012 (CN) 201210293620X

(51) Int. Cl. F16M 7/00

(52) U.S. Cl. CPC F16M 7/00
USPC 248/678; 248/346.01

(57) ABSTRACT

A supporting apparatus for a vending machine is provided. The supporting apparatus includes a supporting frame, four supporting pillars and four reinforcing members. The supporting frame defines a supporting plane for supporting the vending machine. The four supporting pillars extend downwards from four corners of the supporting frame. The four reinforcing members are located at the corner of the supporting frame to stiffen the supporting frame.

### REFERENCE TO RELATED APPLICATIONS

This application claims all benefits accruing under 35 U.S.C. §119 from China Patent Application No. 201210293620.X filed on Aug. 17, 2012 in the State Intellectual Property Office of China, the contents of the China Application are hereby incorporated by reference.

### BACKGROUND

1. Technical Field

The present disclosure generally relates to a supporting apparatus for a vending machine.

2. Description of Related Art

Vending machines have been in common use for purchasing a variety of items. The vending machines carry a number of items and typically have multiple selector buttons or switches to allow a customer to select a specific item. However, when the vending machine is fully loaded with items, the vending machine may be so heavy that a strong supporting apparatus for the vending machine is required.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of an embodiment of a supporting apparatus for a vending machine.

FIG. 2 is an exploded view of the supporting apparatus of FIG. 1.

FIG. 3 is similar to FIG. 2, but viewed from a different aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

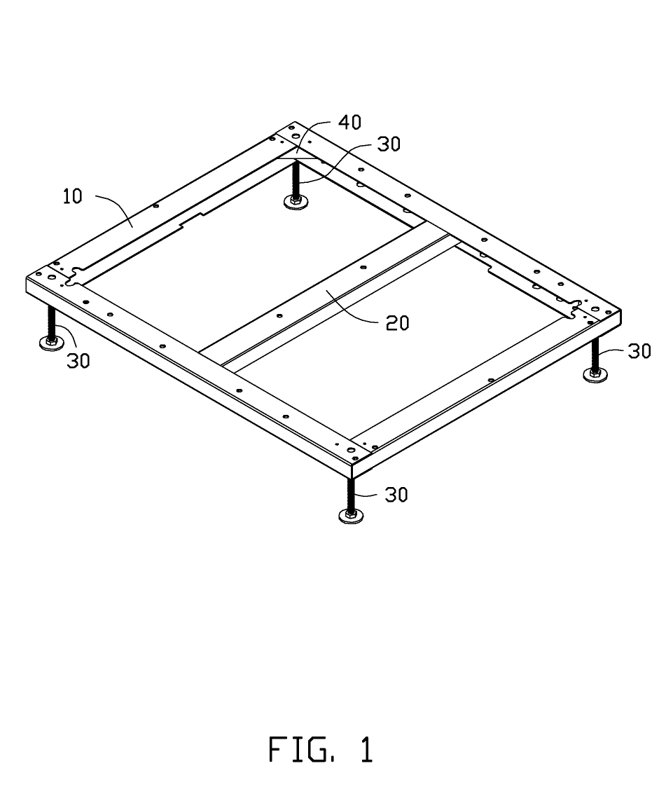

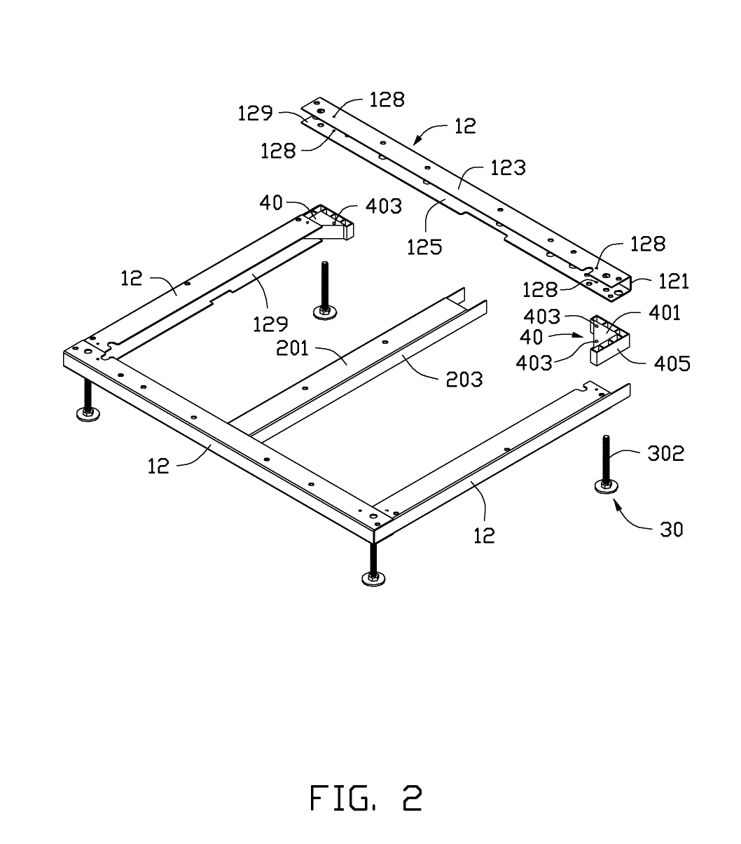

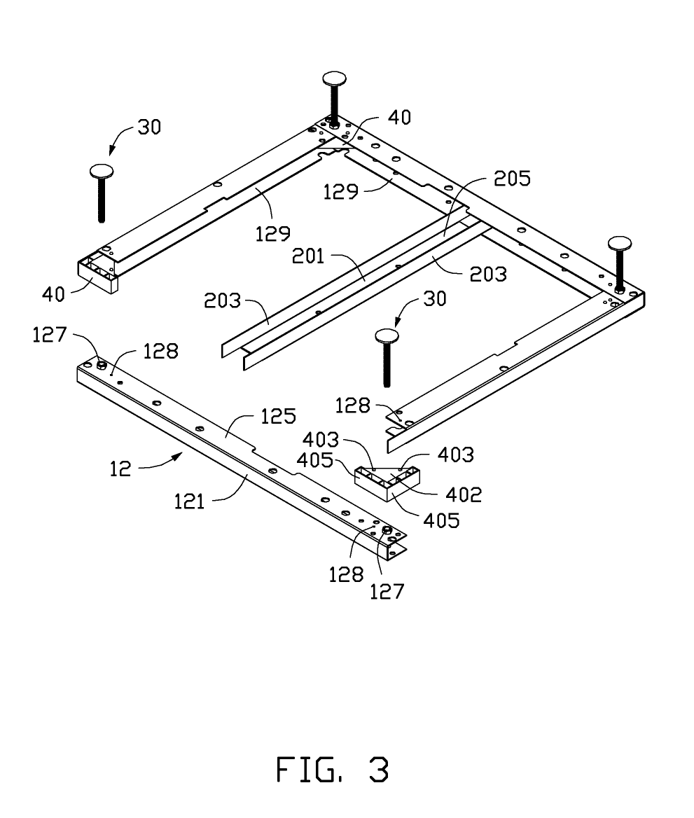

FIGS. 1-3 show an embodiment of a supporting apparatus for a vending machine. The supporting apparatus includes a supporting frame 10, a connecting bar 20, four supporting pillars 30, and four reinforcing members 40.

The supporting frame 10 includes four supporting bars 12. The four supporting bars 12 are connected end to end in sequence and form a rectangle. Each of the four supporting bars 12 includes a sidewall 121, a top wall 123, and a bottom wall 125. The top wall 123 and the bottom wall 125 extend perpendicularly from two opposite edges of the sidewall 121. The top wall 123 and the bottom wall 125 are parallel to each other. The sidewall 121, the top wall 123, and the bottom wall 125 together define an opening 129 towards the center of the supporting frame 10.

The connecting bar 20 interconnects two opposite supporting bars 12 of the supporting frame 10. The connecting bar 20 includes two ends, each of which is connected to a central portion of one of the two opposite supporting bars 12. The supporting frame 10 together with the connecting bar 20 defines a supporting plane, on which a vending machine (not shown) can be placed.

The connecting bar 20 includes a top plate 201 and two side plates 203. The two side plates 203 extend downwards from two opposite edges of the top plate 201. The top plate 201 and the two side plates 203 together define an opening 205. The opening 205 faces down.

The supporting pillars 30 extend downwards from four corners of the supporting frame 10. Each of the four supporting pillars 30 includes a threaded post 302. The threaded post 302 is inserted into a thread hole 127 of the supporting frame 10 thereby mounting the supporting pillars 30 to the corner of the supporting frame 10.

The four reinforcing members 40 are located at the four corners of the supporting frame 10. Each of the four reinforcing members 40 interconnects adjacent two of the supporting bars 12 of the supporting frame 10 and is inserted into the openings 129 of the two contiguous supporting bars 12.

In one embodiment, the reinforcing member 40 is a right-angle triangular prism. The reinforcing member 40 includes a top surface 401, a bottom surface 402, and two side surfaces 405.

The two side surfaces 405 are perpendicular to each other. Each of the two side surfaces 405 contacts the side wall 121 of one of the two contiguous supporting bars 12.

A protrusion 403 protrudes from each of the top surface 401 and the bottom surface 403. Each of the top wall 123 and the bottom wall 125 of the supporting bar 12 defines a mounting hole 128. The protrusion 403 is received in the mounting hole 128. Thus, the reinforcing member 40 is mounted to the two contiguous supporting bars 12 and thereby the two contiguous supporting bars 12 are connected to each other. In the same way, the four supporting bars 12 are assembled to the supporting frame 10 via the four reinforcing members 40.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A supporting apparatus comprising:
a supporting frame defining a supporting plane configured for supporting a vending machine;
a supporting pillar extending downwards from a corner of the supporting frame; and
a reinforcing member located at the corner of the supporting frame and adapted to reinforce the supporting frame.

2. The supporting apparatus of claim 1, wherein the supporting frame is a rectangle and comprises four supporting bars forming each side of the rectangle.

3. The supporting apparatus of claim 2, further comprising a connecting bar interconnecting an opposite pair of the supporting bars of the supporting frame.

4. The supporting apparatus of claim 3, wherein the connecting bar is attached to each of the opposite pair of the supporting bars by connecting each end of the connecting bar to a central portion of each of the opposite pair of the supporting bars of the supporting frame.

5. The supporting apparatus of claim 3, wherein the connecting bar comprises a top plate and two side plates opposite to each other, each of the side plates extending downwards from each edge of the top plate.

6. The supporting apparatus of claim 2, wherein each of the four supporting bars comprises a top wall, a bottom wall, and a sidewall connected to the top wall and the bottom wall.

7. The supporting apparatus of claim 6, wherein the top wall, the bottom wall, and the sidewall together define an opening towards the center of the supporting frame.

8. The supporting apparatus of claim 6, wherein the reinforcing member interconnects adjacent two of the supporting bars.

9. The supporting apparatus of claim 8, wherein the reinforcing member is received in the openings of the adjacent two supporting bars.

10. The supporting apparatus of claim 9, wherein the reinforcing member comprises a top surface, a bottom surface, and a protrusion protruding from each of the top surface and the bottom surface, each of the top wall and the bottom wall defines a mounting hole, the reinforcing member is mounted to the adjacent two of the supporting bars by inserting the protrusion into the mounting hole.

11. A supporting apparatus comprising:
a supporting frame a supporting plane, the supporting frame comprising four supporting bars connected end to end in sequence;
a supporting pillar extending downwards from a corner of the supporting frame; and
a connecting bar interconnecting an opposite pair of the supporting bars of the supporting frame.

12. The supporting apparatus of claim 11, wherein the connecting bar is attached to each of the opposite pair of the supporting bars by connecting each end of the connecting bar to a central portion of one of each of the opposite pair of the supporting bars of the supporting frame.

13. The supporting apparatus of claim 12, wherein the connecting bar comprises a top plate and two side plates opposite to each other, each of the side plates extending downwards from each edge of the top plate.

14. The supporting apparatus of claim 13, wherein the top plate and the two side plates together define an opening facing down.

15. The supporting apparatus of claim 11, further comprising a reinforcing member located at a corner of the supporting frame and adapted to reinforce the supporting frame.

16. The supporting apparatus of claim 15, wherein each of the four supporting bars comprises a top wall, a bottom wall, and a sidewall connected to the top wall and the bottom wall.

17. The supporting apparatus of claim 16, wherein the top wall, the bottom wall, and the sidewall together define an opening towards the center of the supporting frame.

18. The supporting apparatus of claim 17, wherein the reinforcing member interconnects adjacent two of the supporting bars of the supporting frame.

19. The supporting apparatus of claim 18, wherein the reinforcing member is received in the openings of the adjacent two of the supporting bars.

20. The supporting apparatus of claim 19, wherein the reinforcing member comprises a top surface, a bottom surface, and a protrusion protruding from each of the top surface and the bottom surface, each of the top wall and the bottom wall defines a mounting hole, the protrusion is received in the mounting hole thereby mounting the reinforcing member to the adjacent two of the supporting bars.
